(19) United States
(12) Patent Application Publication
(10) Pub. No.: US 2004/0129144 A1
(43) Pub. Date: Jul. 8, 2004

(54) Single stage beer brewing method and system

(76) Inventor: Leigh Patric Beadle, Chapel Hill, NC (US)

Correspondence Address: Leigh P. Beadle, 3751/2 Tenney Circle, Chapel Hill, NC, 27514, US

(21) Appl. No.: 10/336,889

(22) Filed: Jan. 6, 2003

(51) Int. Cl. C12C 11/00

(52) U.S. Cl. 99/275

(57) ABSTRACT

The present invention provides an extremely simple and compact brewing system particularly suited to a restaurant brewpub setting. The system completely eliminates the need for trained brewmasters, cookers, pumps, electric or gas cooker connections, serving tanks or kegs. Heating of the main ingredient, malt extract syrup, is accomplished by simply attaching electric heat belts to the pails of malt syrup. All ingredients are added directly to the combination mixing/fermenting/serving tanks. Fermentation proceeds for the normal time period, after which the tanks are pressurized with CO2, and chilled with a glycol refrigerated chiller unit. The beer is then served directly from the tanks to the customer through standard beer lines and taps.

### CROSS-REFERENCE TO RELATED APPLICATIONS

U.S. Pat. No. 5,718,161 2/1998 Beadle

### STATEMENT REGARDING FEDERALLY SPONSORED RESEARCH OR DEVELOPMENT

Not Applicable.

### REFERENCE TO A MICROFICHE APPENDIX Not Applicable

### BACKGROUND OF THE INVENTION

This invention relates to a system and method for brewing beer, particularly a beer brewing system and method for a restaurant or brewpub setting. Commercial microbrewery and brewpub systems are large and expensive, requiring several hundred square feet of room and the expertise and supervision of a trained brewmaster and at least one assistant. The brewing system of the invention provides a practical alternative to the complicated systems.

The new brewing system and method further simplifies the system in my recent Patent (U.S. Pat. No. 5,718,161 2/1998) by eliminating kegs and cookers, which are the labor intensive and time consuming component of my previous invention.

It is therefore an advantage of this invention to provide a simplified brewing system and method.

A further advantage of this invention is that it provides a system for brewing that requires no electricity or gas connections, vents or pumps for a cooker.

### BRIEF SUMMARY OF THE INVENTION

The present invention provides a single-stage system for brewing beer, comprising a tank that is a combination mixing/fermenting/serving tank. The pre-blended ingredients do not require boiling, only mixing by using hot water already available in all restaurants. Only the malt syrup needs heating for pasteurization and to facilitate mixing. This is done by simply attaching heat belts to the pails shortly before mixing. The brewing system and process of the invention recognizes that this brewing process is so simplified that no trained brewmaster is need. Also, that many standard items in typical brewpubs and micro-breweries, such as cookers, pumps, storage and serving tanks, heat exchangers, filters and kegs are not needed in this system. Other aspects of the invention will become apparent from the following disclosure and appended claims.

### BRIEF DESCRIPTION OF THE SEVERAL VIEWS OF THE DRAWING

FIG. 1 is a block diagram representing a typical prior art brewing system.

FIG. 2 is a block diagram of the brewing system in my prior patent.

FIG. 3 is a block diagram of the present invention showing the elimination of the cooker/pump and kegs.

FIG. 4 shows the modified carbonator design 1, attachment location of the carbonator 2, the carbonator prior art attachment location 3, and the mixing liquid height 4.

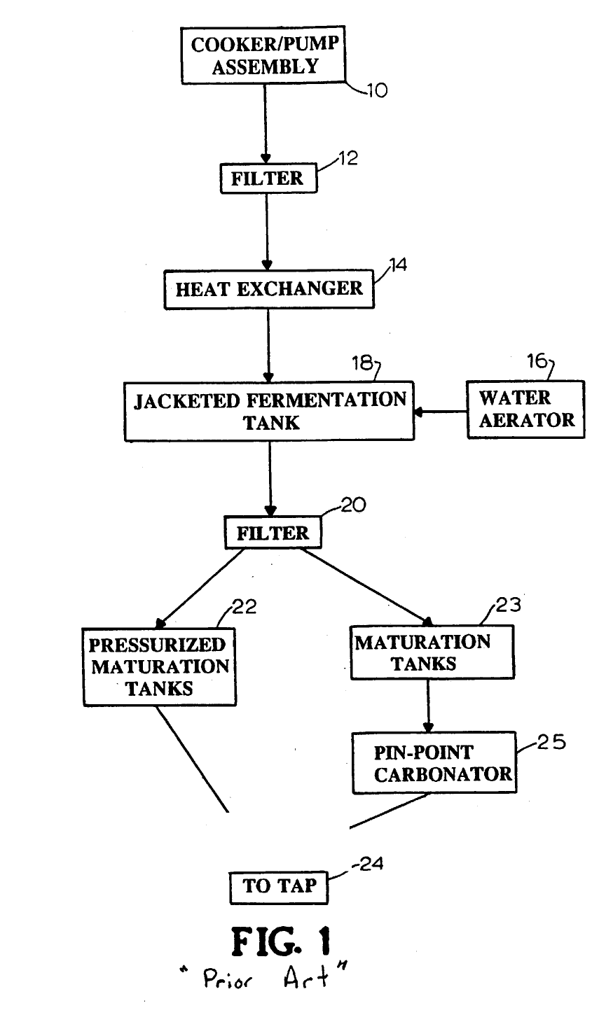

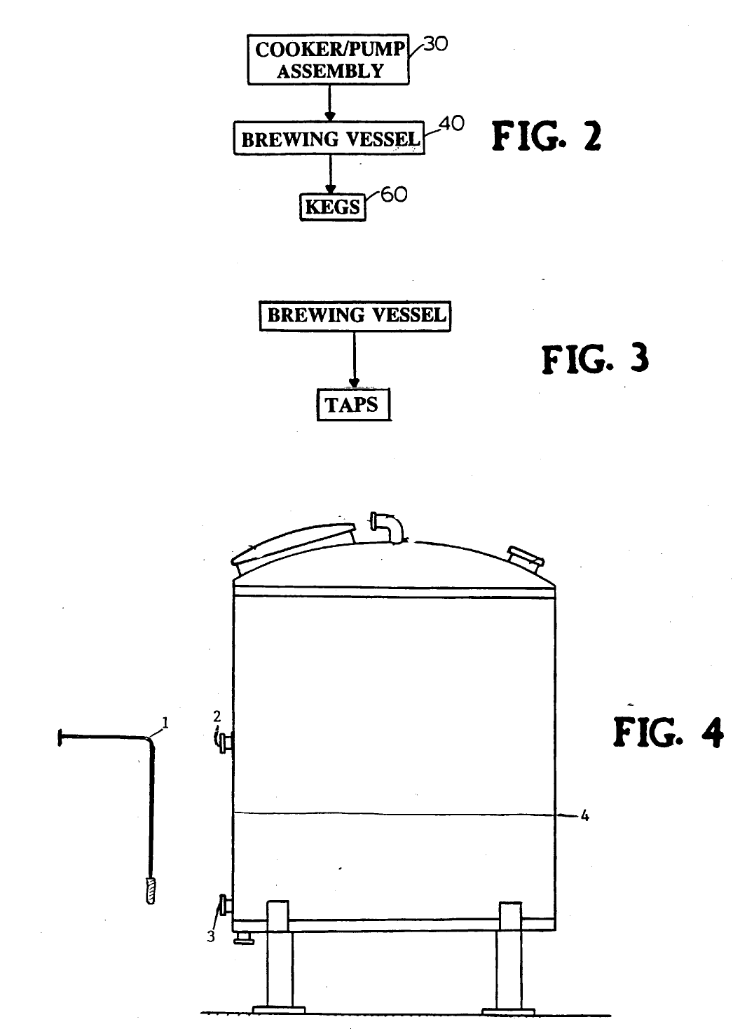

### DETAILED DESCRIPTION OF THE INVENTION

In the present invention, the brewing tank is partially filled with hot water, then maltodextrin, sugar, and malt extract syrup are poured directly into the tank and dissolved, thus eliminating the need for a cooker, pumps, vents, and either electric or gas connections for the cooker. The only ingredient that requires pre-heating and pasteurizing is the malt extract syrup and this is done by simply attaching an electric heat belt around the pails containing the malt extract and warming them to 140 degrees F. These belts are readily available from companies such as Grainger Supply Co., a national distributor, and one of the manufacturers of the Belts is Electro-Flex. FIG. 4 shows a modification of a standard brewing tank that places the carbonator inlet at the middle height of the tank 2 above the liquid level 4 during mixing, instead of the normal bottom inlet 3. The carbonator is modified with a curved tube 1 extending downward as it must be within a foot of the tank bottom to carbonate completely. The tanks are of the type available through many manufacturers such as Mueller Co. of Springfield, Mo. 65801. When the ingredients are dissolved in the tank, the fermentation proceeds. After fermentation is complete, the tank, which is a combination pressure vessel and cooling vessel common in the industry, is sealed. The beer is carbonated and is served through standard beer lines and taps, directly from the tanks to the customer, thus completely bypassing and eliminating the need for kegs, or additional aging and serving tanks.

What I claim as my invention is:

1. A single-stage brewing system comprising:
1. A method of accomplishing the entire brewing process in one combination mixing/fermenting/serving tank, eliminating the need for a cooker, pumps, vents, electric or gas cooker connections, additional serving tanks or kegs.
2. A modification of the carbonator and carbonator inlet to the tank to prevent interference with the mixing process.
